(19) United States
(12) Patent Application Publication
(10) Pub. No.: US 2007/0233651 A1
(43) Pub. Date: Oct. 4, 2007

(54) Online analytic processing in the presence of uncertainties

(75) Inventors: Prasad M. Deshpande, Mumbai (IN); Jayram S. Thathachar, Morgan Hill, CA (US); Shivakumar Vaithyanathan, San Jose, CA (US); Douglas R. Burdick, Madison, WI (US)

Correspondence Address: FREDERICK W. GIBB, III;Gibb & Rahman, LLC, 2568-A RIVA ROAD, SUITE 304, ANNAPOLIS, MD, 21401, US

(73) Assignee: International Business Machines Corporation, Armonk, NY (US)

(21) Appl. No.: 11/395,403

(22) Filed: Mar. 31, 2006

(51) Int. Cl. G06F 17/30

(52) U.S. Cl. 707/3

(57) ABSTRACT

Disclosed are embodiments of a method for online analytic processing of queries and, and more particularly, of a method that extends the on-line analytic processing (OLAP) data model to represent data ambiguity, such as imprecision and uncertainty, in data values. Specifically, the embodiments of the method incorporate a statistical model that allows for uncertain measures to be modeled as conditional probabilities. Additionally, an embodiment of the method further identifies natural query properties (e.g., consistency and faithfulness) and uses them to shed light on alternative query semantics. Lastly, an embodiment of the method further introduces an allocation-based approach to the semantics of aggregation queries over such data.

### BACKGROUND OF THE INVENTION

1. Field of the Invention

The invention relates generally to online analytic processing of queries and, and more particularly, to a method that extends the online analytic processing data model to represent data ambiguity, such as imprecision and uncertainty, in data values.

2. Description of the Related Art

Online analytic processing (OLAP) is a popular human-computer interaction paradigm for analyzing data in large-scale data warehouses. Using a data-model of measures and dimensions, OLAP provides multidimensional views of the data. For example, in a retail transaction a customer buys a product at a particular time for a particular price. In this example, the customer, product and time are axes of interest (i.e., dimensions), while the price is a value of interest (i.e., a measure). The design of OLAP data-models requires a significant amount of domain knowledge in defining the measure attributes and dimensional hierarchies. Dimensions are often associated with hierarchies to facilitate the analysis of the data at different levels of granularity. Navigating through these hierarchies is accomplished via simple but powerful aggregation query mechanisms such as roll-ups and drill-downs. This simplicity has resulted in the wide acceptance of this business intelligence paradigm in the industry.

Recent years have seen an increase in the amount of text in data warehouses. Advanced NLP techniques have been designed that extract useful information from this text. The complication, however, is that this information has an associated inherent uncertainty. Traditional OLAP does not model such uncertainties and it is a challenging problem to generalize the aggregation query mechanisms in OLAP to model and provide consistent views of the data while answering such queries. Therefore, there is a need for an on-line analytical processing method that provides an appropriate framework for modeling imprecision and uncertainty. Therefore, there is a need for an on-line analytical processing method that provides an appropriate framework for modeling imprecision and uncertainty.

### SUMMARY OF THE INVENTION

In view of the foregoing, disclosed are embodiments of a method for online analytic processing of queries over ambiguous data and, and more particularly, of a method that extends the on-line analytic processing (OLAP) data model to represent data ambiguity, such as imprecision and uncertainty, in data values. Specifically, embodiments of the method identify natural query properties and use them to shed light on alternative query semantics. The embodiments incorporate a statistical model that allows for uncertain data to be modeled as conditional probabilities and introduces an allocation-based approach to developing the semantics of aggregation queries over imprecise data. This enables a solution which is formally related to existing, popular algorithms for aggregating probability distributions.

More particularly, embodiments of the method of handling database queries over ambiguous data comprise first associating a plurality of facts with a plurality of values, wherein each value comprises either a known value or an ambiguous value, such as an uncertain value or an imprecise value. A base domain is then established that comprises these values. The uncertain values (e.g., uncertain measure values) can be represented as probability distribution functions (PDFs) over the values in the base domain. For example, each PDF can indicate the different probabilities that are associated with a corresponding uncertain value being either different specific values or within different ranges of specific values. These PDFs can be obtained using a text classifier. For example, since the base domain and the values therein comprise text, a text classifier can be used to analyze the text of the base domain and to output probability distribution functions. The imprecise values (e.g., imprecise dimension values) can be represented simply as subsets of the values in the base domain.

Queries (e.g., aggregation type queries) related to at least one of these facts are then received. Semantics are then developed for processing these queries in the presence of ambiguous data by using a traditional on-line analytic processing (OLAP) system. Specifically, semantics for aggregation queries can be developed by using an allocation-based approach for any imprecise values associated with a fact in said query, by aggregating the PDFs for the uncertain values associated with that fact and by aggregating the known values associated with that fact.

The allocation-based approach can be accomplished by determining all possible values for a specific imprecise value associated with the fact, determining the probabilities that each of the possible values is the correct value of the specific imprecise value and allocating weights to each of the possible values based on the probabilities. The allocating of weights may be iterative.

Aggregation can be accomplished using an aggregation operator. Optionally, prior to aggregation of the PDFs for the uncertain values, those PDFs can be selectively weighted.

Aggregation queries can comprise, for example, SUM queries, AVERAGE queries, COUNT queries and aggregation linear operation (AggLin OP) queries. Thus, query semantics are developed so as to include formulas for determining the answers to SUM, AVERAGE and COUNT queries for known values associated with the fact and a formula for determining the answer to an aggregation linear operation (AggLinOp) query for uncertain values associated with the fact. The semantics will be implemented to determine the query answer by using corresponding algorithms for computing the formulas, discussed above.

These, and other, aspects and objects of the present invention will be better appreciated and understood when considered in conjunction with the following description and the accompanying drawings. It should be understood, however, that the following description, while indicating embodiments of the present invention and numerous specific details thereof, is given by way of illustration and not of limitation. Many changes and modifications may be made within the scope of the present invention without departing from the spirit thereof, and the invention includes all such modifications.

### BRIEF DESCRIPTION OF THE DRAWINGS

The invention will be better understood from the following detailed description with reference to the drawings, in which:

FIG. 1 is a flow diagram illustrating an embodiment of the method of the invention;

FIG. 2 is an exemplary fact table for sample data in a CRM application for automobiles;

FIG. 3 is a multidimensional view diagram of the sample data of FIG. 2;

FIG. 4 is a diagram illustrating two forms of faithfulness; and

FIG. 5 is a diagram illustrating possible worlds.

### DETAILED DESCRIPTION OF PREFERRED EMBODIMENTS OF THE INVENTION

The embodiments of the invention and the various features and advantageous details thereof are explained more fully with reference to the non-limiting embodiments that are illustrated in the accompanying drawings and detailed in the following description. It should be noted that the features illustrated in the drawings are not necessarily drawn to scale. Descriptions of well-known components and processing techniques are omitted so as to not unnecessarily obscure the embodiments of the invention. The examples used herein are intended merely to facilitate an understanding of ways in which the embodiments of the invention may be practiced and to further enable those of skill in the art to practice the embodiments of the invention. Accordingly, the examples should not be construed as limiting the scope of the embodiments of the invention.

As mentioned above, in recent years there has been an increase in the amount of text in data warehouses. Advanced NLP techniques have been designed that extract useful information from this text. However, this information has an associated inherent uncertainty which is not modeled by traditional OLAP. Thus, there is a need for an on-line analytical processing method that provides an appropriate framework for modeling uncertainties. Therefore, disclosed herein are embodiments of a method for online analytic processing (OLAP) of queries and, more particularly, of a method that extends the on-line analytic processing (OLAP) data model to represent data ambiguity, such as imprecision and uncertainty, in data values. Specifically, embodiments of the method identify natural query properties and use them to shed light on alternative query semantics. The embodiments incorporate a statistical model that allows for uncertain data to be modeled as conditional probabilities and introduces an allocation-based approach to developing the semantics of aggregation queries over imprecise data. This enables a solution which is formally related to existing, popular algorithms for aggregating probability distributions. Additionally, embodiments of the method of the invention (1) introduce criteria (e.g., consistency, faithfulness, and correlation-preservation) that guide the choice of semantics for aggregation queries over ambiguous data and (2) provide a possible-worlds interpretation of data ambiguity that leads to a novel allocation-based approach to defining semantics for aggregation queries.

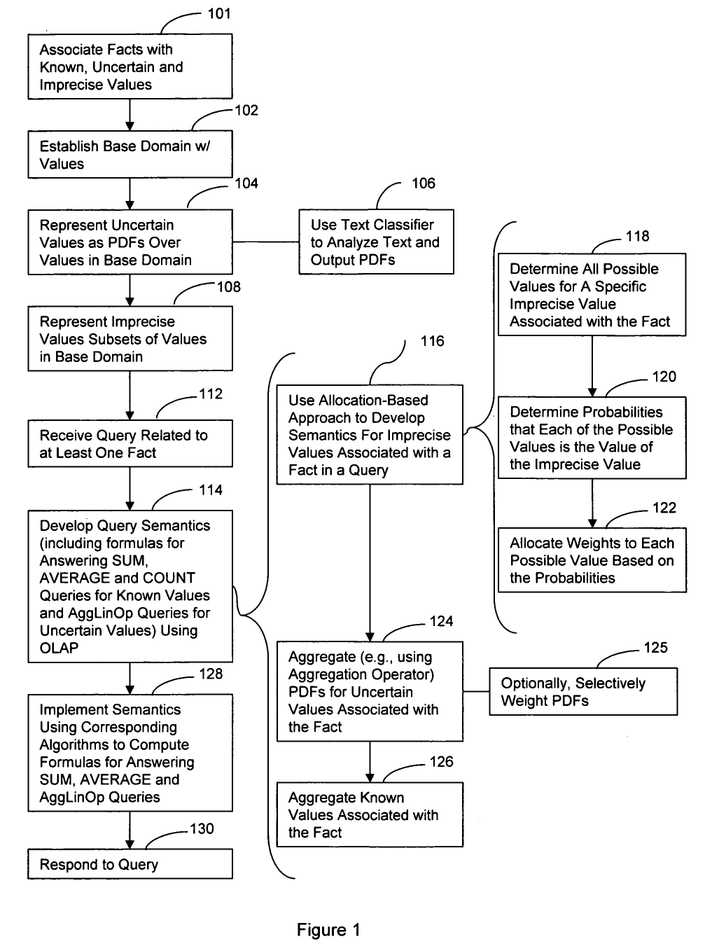

Referring to FIG. 1, embodiments of the method of handling database queries comprise first associating a plurality of facts with a plurality of values, wherein each value comprises either a known value or an ambiguous value, such as an uncertain value or an imprecise value (101). A base domain is then established that comprises these values (102). The uncertain values can be represented as probability distribution functions (PDFs) over the values in the base domain (104). For example, each PDF can indicate the different probabilities that are associated with a corresponding uncertain value being either different specific values or within different ranges of specific values. These PDFs can be obtained using a text classifier (106). For example, since the base domain and the values therein comprise text, a text classifier can be used to analyze the text of the base domain and to output probability distribution functions. The imprecise values can be represented simply as subsets of the values in the base domain (108).

Queries (e.g., aggregation type queries) related to these facts are then received (112). Then, query semantics for answering these queries are developed in the presence of ambiguous data (i.e., imprecise and/or uncertain values) (114) using a traditional on-line analytic processing system. Specifically, the query semantics can be developed using allocation-based approach for imprecise values associated with a fact (116) by aggregating PDFs for uncertain values associated with that fact (124) and by aggregating known values associated with that fact (126).

The allocation-based approach (116) can be accomplished by determining all possible values for a specific imprecise value associated with the fact (118), determining the probabilities that each of the possible values is the correct value of the specific imprecise value (120) and allocating weights to each of the possible values based on the probabilities (122). The allocating of weights may be iterative.

Aggregation (at processes 124 and 126) can be accomplished using an aggregation operator. Optionally, prior to aggregation of the PDFs for the uncertain values (at process 124), those PDFs can be selectively weighted (125).

Aggregation queries can comprise, for example, SUM queries, AVERAGE queries, COUNT queries and aggregation linear operation (AggLin OP) queries. The query semantics can be developed so as to include formulas for determining the answers to the SUM, AVERAGE and/or COUNT queries for known values associated with the fact and a formula for determining the answer to an aggregation linear operation (AggLinOp) query for uncertain values associated with the fact. The semantics will then be implemented to process and answer the query (128). Implementation will be accomplished using corresponding algorithms for computing the above mentioned formulas.

More particularly, embodiments of the method of this invention provide an extended data model in which the standard multidimensional data model is generalized, incorporating imprecision and uncertainty. Specifically, attributes in the standard OLAP model are of two kinds dimensions and measures. The model is extended to support uncertainty in measure values (i.e., uncertain values) and imprecision in dimension values (i.e., imprecise values).

Uncertain values or domains can be represented as probability distribution functions (PDFs) over the values in the base domain (see processes 104-106 of FIG. 1). For example, an uncertain domain U over base domain B can be defined as the set of all possible probability distribution functions, or pdfs, over B. Thus, each value u in U is a pdf that, intuitively, indicates our degree of belief that the “true” value being represented is b, for each b in the base domain B. For instance, instead of a single sales number, we might have a pdf over a base domain of sales-range numbers, for example,
{ [symbol] $0-$30,0.2 [symbol] , [symbol] $31-$60,0.6 [symbol] , [symbol] $61-$100,0.2 [symbol] }.

Imprecise values or domains can be represented simply as subsets of the values in the base domain (see process 108 of FIG. 1). For example, an imprecise domain I over a base domain B can be defined as a subset of the powerset of B with φ∉I; elements of I are called imprecise values (see process 108). Intuitively, an imprecise value is a non-empty set of possible values. Allowing dimension attributes to have imprecise domains enables us, for example, to use the imprecise value ‘Wisconsin’ for the location attribute in a data record if we know that the sale occurred in Wisconsin but are unsure about the city. In OLAP, each dimension has an associated hierarchy, e.g., the location dimension might have attributes city and state, with state denoting generalizations of city; this suggests a natural special case of imprecise domains called hierarchical domains, which we define next.

A hierarchical domain H over base domain B can be defined as an imprecise domain over B such that (1) H contains every singleton set (i.e., corresponds to some element of B) and (2) for any pair of elements
h₁, h₂εH, h₁⊃h₂ or h₁∩h₂=φ

Intuitively, each singleton set is a leaf node in the domain hierarchy and each non-singleton set in His a non-leaf node; thus, ‘Madison,’ ‘Milwaukee,’ etc. are leaf nodes with parent ‘Wisconsin’ (which, in turn might have ‘USA’ as its parent). We will often refer to a hierarchical domain in terms of leaf and non-leaf nodes, for convenience.

A fact table schema is [symbol] A₁, A₂, . . . , Aₖ; M₁, . . . Mₙ [symbol] where (i) each dimension attribute Aᵢ, iε1 . . . k, has an associated domain dom(Aᵢ) that is imprecise, and (ii) each measure attribute Mⱼ, jε1 . . . n, has an associated domain dom(Mⱼ) that is either numeric or uncertain. A database instance of this fact table schema is a collection of facts of the form [symbol] a₁, a₂, . . . , aₖ; m₁, . . . , nₙ [symbol] , where aᵢεdom(Aᵢ), iε1 . . . k and mⱼεdom(Mⱼ), jε1 . . . n. In particular, if dom(Aᵢ) is hierarchical, aᵢ can be any leaf or non-leaf node in dom(Aᵢ). Consider a fact table schema with dimension attributes A₁, A₂, . . . , Aₖ. A vector [symbol] c₂, c₂, . . . , cₖ [symbol] is called a cell if every cᵢ is an element of the base domain of Aᵢ, iε1 . . . k. The region of a dimension vector [symbol] a₁, a₂, . . . , aₖ [symbol] is defined to be the set of cells { [symbol] c₁, c₂, . . . , cₖ [symbol] |cᵢεaᵢ, iε1 . . . k} Let reg(r) denote the region associated with a fact r. Also, consider a fact table schema with dimension attributes A₁, A₂, . . . , Aₖ that all have hierarchical domains and consider a k-dimensional space in which each axis i is labeled with the leaf nodes of dom(Aᵢ). For every region, the set of all cells in the region is a contiguous k-dimensional hyper-rectangle that is orthogonal to the axes. If every dimension attribute has a hierarchical domain, there is an intuitive interpretation of each fact in the database as a region in a k-dimensional space. If all aᵢ are leaf nodes, the observation is precise, and describes a region consisting of a single cell. If one or more Aᵢ are assigned non-leaf nodes, the observation is imprecise and describes a larger k-dimensional region. Each cell inside this region represents a possible completion of an imprecise fact, formed by replacing non-leaf node aᵢ with a leaf node from the subtree rooted at aᵢ. The process of completing every imprecise fact in this manner represents a possible world for the database (see detailed discussion below).

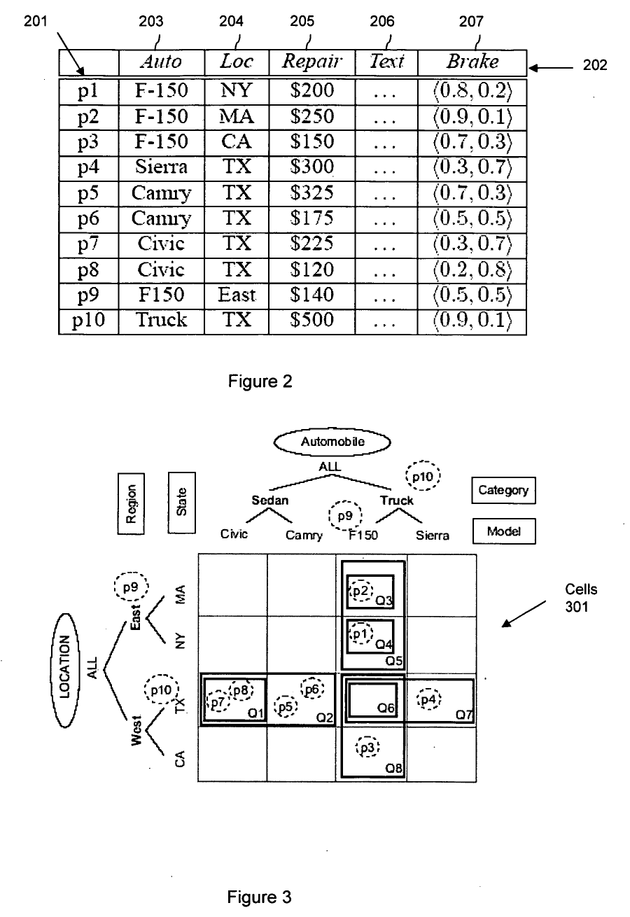

For example, referring to the table of FIG. 2, a plurality of facts 201 (e.g., p1-p10) are associated with a plurality of values 202 (e.g., auto 203, location 204, repair 205, text 206, brake 207, etc.) (see process 101 of FIG. 1). Consider the scenario of a car manufacturer using a CRM application to track and manage service requests across its worldwide dealer operations. Each fact 201 describes an “incident”. The first two columns of values are dimension attributes of Automobile (Auto) 203 and Location (Loc) 204. These dimension attributes take values from their associated hierarchical domains. The structure of these domains and the regions of the facts are shown in the diagram of FIG. 3. Specifically, precise fact values 302 (e.g., precise values of facts p1-p8) in the table of FIG. 2 have leaf nodes assigned to both of these dimension attributes 203, 204 and are mapped to the appropriate cells 301 in the diagram of FIG. 3. Values of facts p9 and p1, on the other hand, are imprecise (i.e., imprecise values 303). Fact p9 is imprecise because the Location 204 dimension is assigned to the non-leaf node ‘East,’ and its region contains the cells 301 (‘NY’, ‘F150’) and (‘MA’, ‘F150’). Similarly, the region for p10 contains the cells 301 (‘TX’, ‘F150’) and (‘TX’, ‘Sierra’). Each fact 201 (e.g., p1-p10) contains a value for the numeric measure attribute Repair 205 denoting the repair cost associated with the incident.

In order to classify incidents based on the type of problem (e.g., “brake”, “transmission”, “engine noise” etc.), as described in the auxiliary Text 206 attribute, there exists a classifier (e.g., as illustrated in reference [1]) that outputs a discrete probability distribution based on analyzing the content of the Text 205 attribute (see processes 104-106 of FIG. 1). The pdf output reflects the uncertainty inherent in such classifiers. For example, each PDF can indicate the different probabilities that are associated with a corresponding uncertain value being either different specific values or within different ranges of specific values. In the example illustrated in FIG. 2, there is a single topic “brake” 207, and the classifier output for whether the Text 206 attribute describes a brake problem is represented as a pdf over two values ‘Yes’ and ‘No’, and is stored in the uncertain measure attribute Brake 207 as a pair of probabilities. Thus, for example, the pair of probabilities for the uncertain fact value of a brake problem 207 associated with fact p1 is 0.8 and 0.2, for yes and no, respectively.

While the OLAP paradigm offers a rich array of query operators, the basic query consists of selecting a node for one or more dimensions and applying an aggregation operator to a particular measure attribute. For example, selecting the Location node ‘TX’ and the Automobile node ‘Civic’ and applying SUM to the Repair measure returns the total amount spent on repairs of ‘Civic’ cars in Texas. All other queries (such as roll-up, slice, drill-down, pivot, etc.) can be described in terms of repeated applications of basic queries. Thus, the embodiments of the method disclosed herein concentrate on the semantics of basic queries in light of two data model extensions to the full array of known OLAP query operators.

Specifically, a query Q over a database D with schema has the form Q(a₁, . . . , aₖ; Mᵢ, A), where: (i) a₁, . . . , aₖ describes the k-dimensional region being queried, (ii) Mᵢ describes the measure of interest, and (iii) A is an aggregation function. The result of Q is obtained by applying A to a set of facts find-relevant (a₁, . . . , aₖ, D) (which is discussed below). The function find-relevant identifies the set of facts in D deemed “relevant” to the query region, and the appropriate definition of this function is an important issue addressed herein. All precise facts within the query region are naturally included, but there are important design decisions with respect to imprecise facts that must be considered.

Embodiments of the method of the invention can incorporate a predetermined plan that denotes how the imprecise values are to be considered. Generally, there are three options: ignore all imprecise facts (the None option), include only those contained in the query region (the Contains option), or include all imprecise facts whose region overlaps the query region (Overlaps option). As will be discussed in further detail below, the only appropriate option is the Overlaps option. More particularly, handling imprecise facts, when answering queries, is central to the embodiments of this invention, which are illustrated through the example below (see also discussion below regarding the various options for determining the facts relevant to a query).

Referring to FIGS. 2-3 in combination, consider, for example, aggregate queries of the type “What are the repair costs for F150's in the East?” (i.e., a SUM aggregate value for the measure attribute Repair in the region denoted by (‘F150’, ‘East’)). All queries 304 (e.g., Q1-Q8) are depicted in FIG. 3 as boxes enclosing the query region and the above example query corresponds to Q5.

For queries 304, whose regions do not overlap any facts with imprecise values 303 (i.e., imprecise facts), e.g., Q1 and Q2, the set of relevant facts is clear. For other queries, e.g., Q5, this is trickier. If the predetermined plan of process 116 uses the None option, the result of Q5 is A(p1,p2) and the imprecise fact p9 is ignored. If the predetermined plan of process 116 uses the Contains option, the result is A(p1,p2,p9). Which answer is better? Using p9 to answer Q5 seems reasonable since the region for Q5 contains p9, and the result reflects all available data. However, there is a subtle issue with using the Contains option to determine relevant facts. In standard OLAP, the answer for Q5 is the aggregate of answers for Q3 and Q4, which is clearly is not the case now, since Q3=A(p2) and Q4=A(p1). Observing that p9 “overlaps” the cells c1=(‘F150’,‘NY’) and c2=(‘F150’,‘MA’), it may be advisable to choose a predetermined plan that partially assigns p9 to both cells, a process that is referred to herein as allocation (see process 118). In an allocation-based plan the partial assignment can be captured by the weights w_{c1} and w_{c2}, such that w_{c1}+w_{c2}=1, which reflect the effect p9 should have on the aggregate value computed for cells c1 and c2, respectively. Thus, if the Overlap option is used with the allocation-based plan, then Q3=A(p2, w_{C1}*p9) and Q4=A(p1, w_{c2}*p9).

Note that the “expected” relationship between Q3, Q4, and Q5 is maintained and thus, consistency is maintained. In addition to consistency, there is a notion of result quality relative to the quality of the data input to the query, which is referred to herein as faithfulness. For example, the answer computed for Q3 should be of higher quality if p9 were precisely known. Consistency and faithfulness are discussed in greater detail below, as are the possible-world semantics underlying allocation (116) and aggregation (124-126) algorithms.

Referring again to FIGS. 2-3 in combination, to further illustrate the role of allocation (at process 116), consider query Q6. If p0 is allocated to all cells 301 in its region then Q6 can be answered. Otherwise, the answer to Q6 is undefined, as in regular OLAP. Although allocation at process 116) can be accomplished in several ways it is reasonable to expect that allocation is query independent. For example, Q7 and Q8 must be answered using the same allocation for p10.

Since uncertain measures (i.e., uncertain values) are represented as pdfs over some base domain (see processes 104-106 of FIG. 1), the answer to any query is an aggregation of measure pdfs in the facts relevant to that query (see process 122 of FIG. 1). This notion of aggregating pdfs is closely related to the problem studied in the statistics literature under the name of opinion pooling as described in reference [2]. Informally, the opinion pooling problem is to provide a consensus opinion from a set of opinions Θ. The opinions in Θ as well as the consensus opinion are represented as pdfs over a discrete domain O. Many pooling operators have been studied, and the linear operator LinOp is among the most widely used. LinOp(Θ) produces a consensus pdf P̅ that is a weighted linear combination of the pdfs in Θ, i.e., P̅(x)=Σ_{Pεθ}wp·P(x), for xεO. Here, the weights are non-negative quantities summing to one. Unless there is some form of prior knowledge, we assume that the weights are uniform, i.e., wp=1/|Θ|, in which case P̅(x) is just the average of the probabilities P̅(x) for PεΘ. However, the pdfs can be selectively weighted (see process 120). This observation has the important consequence that LinOp can be efficiently computed using existing aggregation functions in current OLAP systems.

In providing support for OLAP-style queries in the presence of imprecision and uncertainty, embodiments of the method of the invention provide that the answers to these queries should meet a reasonable set of requirements that can be considered generalizations of requirements met by queries in standard OLAP systems. Thus, an embodiment of the method disclosed herein establishes at least two requirements for handling imprecision, namely consistency and faithfulness, which apply to both numeric and uncertain measures. It is noted that some requirements for handling uncertainty have been proposed in reference [3].

Consistency criteria can be based on an expectation that other aggregate probability distribution functions based on facts related to the query facts will be consistent. In other words, the intuition behind the consistency requirement is that a user expects to see some natural relationships hold between the answers to aggregation queries associated with different (connected) regions in a hierarchy. For example, let a represents consistency. Let α(x, x₁, x₂, . . . , xₚ) be a predicate such that each argument of a takes on values from the range of a fixed aggregation operator A. Consider a collection of queries Q, Q₁, . . . , Qₚ such that: (1) the query region of Q is partitioned by the query regions of Q₁, . . . , Qₚ, i.e., reg(Q)=∪ᵢreg(Qᵢ) and reg(Qᵢ)∩reg(Qⱼ)=φ for every i≠j, and (2) each query specifies that A be applied to the same measure attribute. Let \hat{q}, \hat{q}₁, . . . , \hat{q}ₘ denote the associated set of answers on D. Thus, an algorithm satisfies α-consistency with respect to A if (\hat{q}, \hat{q}₁, . . . , \hat{q}ₚ) holds for every database D and for every such collection of queries Q, Q₁, . . . , Qₚ. This notion of consistency is in the spirit of the idea of summarizability that was introduced in references [4] and [5], although the specific goals are different. Given the nature of the underlying data, only some aggregation functions are appropriate, or have the behavior the user expects.

The following is provided to instantiate appropriate consistency predicates for the aggregation operators used in processes 124 and 126. Consider SUM and COUNT. Since SUM is a distributive function, the intuitive notion of consistency for SUM is that the SUM for a query region should equal the value obtained by adding the results of SUM for the query sub-regions that partition that region. Using the notations given in the definition of α-consistency, the following consistency predicate for SUM is defined as \hat{q}=Σᵢ\hat{q}ᵢ. It should be noted that all statements for SUM, mentioned herein, are similarly applicable to COUNT and will not be explicitly mentioned.

Consider also AVERAGE. The AVERAGE for a query region should be within the bounds of values obtained by computing the AVERAGE for the query sub-regions that partition that region. The notion of consistency for AVERAGE is defined as (i) \hat{q}≧minᵢ{\hat{q}ᵢ} and (ii) \hat{q}≦maxᵢ{\hat{q}ᵢ}. Thus, the intuitive notion of consistency for aggregating pdfs is similar to that for AVERAGE. Each component of the result pdf \hat{q} for a region should be within the bounds of that component for the results of all sub-regions that partition that region. Let \hat{q}(o) denote the component for the element o in the base domain of the uncertain measure. Consider also LinOp. LinOp-Consistency is defined as follows: for all oεO, (i)\hat{q}(o)≧minᵢ{\hat{q}ᵢ(o)} and (ii) \hat{q}(o)≦maxᵢ{\hat{q}ᵢ(o)}. An important consequence of the various α-consistency properties defined above is that the Contains option may not be particularly suitable for handling imprecision because it is theorized that there exists a SUM aggregate query which violates SUM-Consistency when the Contains option is used to find relevant imprecise facts in find-relevant. Similar theorems can be shown for other aggregation operators as well.

Faithfulness criteria can be based on an expectation that the aggregated probability distribution function for a query will be remain essentially the same even if additional imprecise values that are not related to the query are added to the base domain. For example, suppose the imprecision in a starting database D is increased by mapping facts in the database to larger regions. It is expected that the answer to any query Q on this new database D′ will be different from the original answer. Faithfulness is intended to capture the intuitive property that this difference should be as small as possible. Since an aggregation algorithm only gets to see D′ as its input and is not aware of the “original” database D one cannot hope in general to state precise lower and upper bounds for this difference. The aim of the faithfulness criteria instead will be to state weaker properties that characterize this difference, e.g., whether it is monotonic with respect to the amount of imprecision. The following definitions may be helpful in formalizing faithfulness.

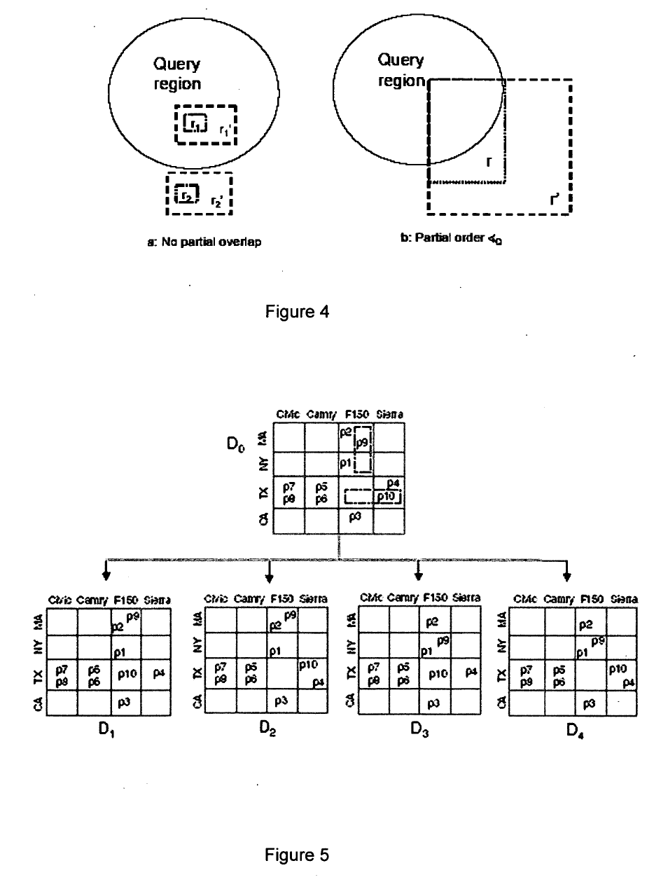

Measure-similar Databases. Two databases D and D′ can be defined as measure-similar if D′ is obtained from D by (arbitrarily) modifying the (only) dimension attribute values in each fact r. Let r′εD′ denote the fact obtained by modifying rεD; we say that r corresponds to r′. The two measure-similar databases D and D′ are precise with respect to query Q if for every pair of corresponding facts rεD and r′εD′, neither r nor r′ overlaps the query region reg(Q) or both are contained in reg(Q). FIG. 4a illustrates the definition of measure-similar databases.

Basic faithfulness. An algorithm satisfies basic faithfulness with respect to an aggregation function A if for every query Q that uses A, the algorithm gives identical answers for every pair of measure-similar databases D and D′ that are precise with respect to Q. In particular, if D has only precise facts, then basic faithfulness requires that every fact in D′ that lies within the query region should be treated as if it were precise and that facts outside the query region should not affect the query result a completely reasonable requirement since the imprecision in the facts does not cause ambiguity with respect to the query region. Thus, it can be argued that due to basic faithfulness, the None option of handling imprecision by ignoring all imprecise records is inappropriate. Specifically, it is theorized that SUM, COUNT, AVERAGE and LinOp violate basic faithfulness when the None option is used to handle imprecision. Therefore, the unsuitability of both the Contains and None options for handling imprecision is demonstrated and the remaining option, namely Overlaps, is the focus of the embodiments of the method of the invention.

The next form of faithfulness is intended to capture the same intuition as basic faithfulness in the more complex setting of imprecise facts that partially overlap a query. Thus, an ordering is defined that compares the amount of imprecision in two databases with respect to a query Q so as to reason about the answers to Q as the amount of imprecision grow.

Partial order [symbol] _{Q}. Fix a query Q. Then, the relation I_{Q} (D, D′) holds on two measure-similar databases D and D′ if all pairs of corresponding facts in D and D′ are identical, except for a single pair of facts rεD and r′εD′ such that reg(r′) is obtained from reg(r) by adding a cell c∉reg(Q)∪reg(r). Thus, the partial order [symbol] _{Q} can be defined as the reflexive, transitive closure of I_{Q}. FIG. 4b illustrates the definition of [symbol] _{Q} for a query the amount of imprecision for every fact r′εD′ is larger than that of the corresponding fact rεD but only in the cells outside the query region. The reason for this restriction is that allowing r′ to have a larger projection inside the query region does not necessarily mean that it is less relevant to Q than r (cf. basic faithfulness).

β-faithfulness. Let β(x₁,x₂, . . . , xₚ) be a predicate such that the value taken by each argument of β belongs to the range of a fixed aggregation operator A. Then, an algorithm can satisfy β-faithfulness with respect to A if for any query Q compatible with A, and for any set of databases D₁ [symbol] _{Q}D₂ [symbol] _{Q} . . . [symbol] _{Q}Dₚ, the predicate β(\hat{q}₁, . . . , \hat{q}ₚ) holds true where \hat{q}ᵢ denotes the answer computed by the algorithm on Dᵢ, i in 1 . . . p. β-faithfulness applies to the aggregation operations considered herein. Specifically, if SUM is considered over non-negative measure values, the intuitive notion of faithfulness is that as the data in a query region becomes imprecise and grows outside the query region, SUM should be non-increasing. SUM-faithfulness can be defined as follows: if D₁ [symbol] _{Q}D₂, then \hat{q}_{D}_{₁}≦\hat{q}_{D}_{₂}. Unfortunately, defining an appropriate instance of β-faithfulness for AVERAGE and LinOp is difficult. Consider how the AVERAGE behave as facts in a query region become more imprecise and grow outside the query region: SUM for the query region diminishes, but the count also decreases. Since both the numerator and denominator are decreasing, the value of AVERAGE could either increase or decrease. The same observation applies to LinOp as well.

Additionally, disclosed herein, is a possible-worlds interpretation of a database D containing imprecise facts, similar to that proposed in reference [6], as a prelude to defining query semantics when the Overlaps option is used to find relevant facts (at process 114). Consider an imprecise fact r which maps to a region R of cells. Recall from the above-discussion regarding FIGS. 2-3, that each cell in R represents a possible completion of r that eliminates the imprecision in r. Repeating this process for every imprecise fact in D leads to a database D′ that contains only precise facts. That is, when using an allocation-based approach to develop semantics for imprecise values associated with a fact, all possible values for that specific imprecise value are determined (see processes 116-118). Thus, D′ is a possible world for D, and the multiple choices for eliminating imprecision lead to a set of possible worlds for D. Possible worlds are illustrated in the following example.

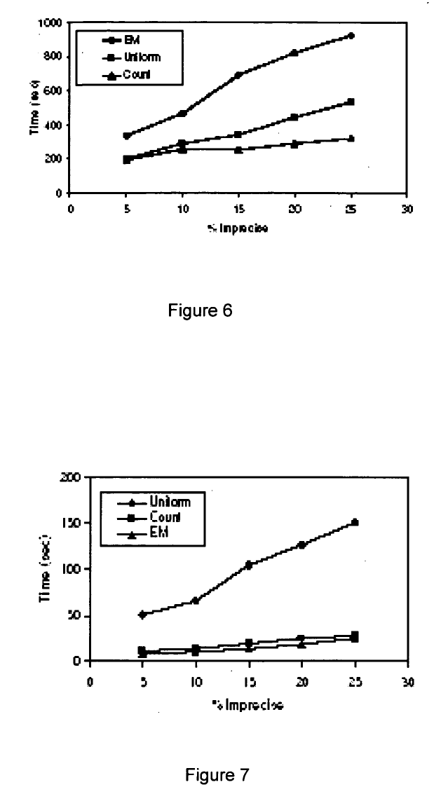

FIG. 5 shows a multidimensional view of the data in our running example (FIGS. 2-3), together with all four possible worlds that can be generated by making the two imprecise facts p9 and p10 precise. Fact p9 can be made precise in two possible ways, placing it in cell

(MA, F150) or (NY, F150). Similarly, p10 can be made precise in two possible ways, placing it in (TX, F150) or (TX, Sierra). Different combinations of these (2*2) choices lead to the possible worlds {D₁, D₂, D₃ and D₄}.

The possible worlds {D₁, D₂, . . . , Dₘ} are interpreted as the collection of “true” databases from which the given database D was obtained; the likelihoods of each possible world being the “true” one are not necessarily the same. To capture this likelihood, a non-negative weight wᵢ is associated with each Dᵢ, normalized so that Σᵢwᵢ=1. The weights give us flexibility to model the different behaviors that cause imprecision, while the normalization allows for a probabilistic interpretation of the possible worlds.

Thus, for example, if there are k imprecise facts in a dataset D, and the region for the i^{th} imprecise fact contains cᵢ cells, the number of possible worlds is prodᵢ₌₁^{k}cᵢ. To tackle the complexity due to this exponential number of possible worlds, each imprecise fact r must be considered and assigned a probability (at process 120) for its “true” value being c, for each cell c in its region. The assignments for all imprecise facts collectively (and implicitly) associate probabilities (weights) with each possible world (see process 120-122).

Specifically, allocation (at process 116) can be defined as the assignments of weights to a specific value being the correctly identified as the imprecise value based on probabilities (see process 118-122). For a fact r and a cell cεreg(r), let P_{c,r} denote the probability that r is completed to c in the underlying “true” world. P_{c,r} is the allocation of fact r to cell c, and sum_{cεreg(r)}p(c,r)=1. Consider the following probabilistic process, starting with a database D containing k imprecise facts. Independently for each imprecise fact rᵢ, pick a cell cᵢ with probability p_{ci,ri} and modify the dimension attributes in rᵢ so that the resulting fact belongs to cell cᵢ. The set of databases that can arise via this process constitute the possible worlds. The weight associated with a possible world D′ equals prodᵢ₌₁^{k}p_{ci,ri}. Any procedure for assigning p_{c,r} is referred to as an allocation policy. The result of applying such a policy to a database D is an allocated database D*. The schema of D* contains all the columns of D plus additional columns to keep track of the cells that have strictly positive allocations. Suppose that fact r in D has a unique identifier denoted by ID(r). Corresponding to each fact rεD, we create a set of fact(s) [symbol] (ID(r), r, c, P_{c,r} [symbol] in D* for every c such that P_{c,r}>0. Allocation policies are described in greater detail below. The size of D* increases only linearly in the number of imprecise facts. However, since the region of an imprecise fact is exponentially large in the number of dimension attributes which are assigned non-leaf nodes, care must be taken in determining the cells that get positive allocations.

For the example in FIG. 3, suppose that the probabilities for p9 are 0.6 and 0.4 for cells (MA, F150) and (NY, F150) respectively. Then in D* two facts are created corresponding to p11—one belonging to (MA, F150) with weight 0.6 and another to (NY, F150) with weight 0.4 both tagged with the same identifier. Similarly there are 2 facts for p10, belonging to (TX, F150) and (TX, Sierra) with the same id, p10.

To summarize possible worlds, the allocation weights encode a set of possible worlds, {D₁, . . . , Dₘ} with associated weights w₁, . . . , wₘ. The answer to a query Q is a multiset {v₁, . . . , vₘ}. Thus, the problem of appropriate semantics for summarizing {v₁, . . . , vₘ} remains. Recall that the weights give a probabilistic interpretation of the possible worlds, i.e., database Dᵢ is chosen with probability wᵢ. The possible answers {v₁, . . . , vₘ} are summarized by defining a discrete random variable, Z, associated with this distribution (i.e., an answer variable). Consider the multiset {v₁, . . . , vₘ} of possible answers to a query Q. The answer variable Z associated with Q can be defined to be a random variable Pr[Z=v]=Σ_{is,t,v}_{ᵢ}₌ᵥwᵢ. The answer to a query can be summarized as the first and the second moments (expected value and variance) of the answer variable Z. Using E[Z] to answer queries is justified because it is theorized that basic faithfulness can be satisfied if answers to queries are computed using the expected value of the answer variable.

For computational purposes approximations to the expected value are also considered. The above approach of summarizing possible worlds for answering aggregation queries, though intuitively appealing, complicates matters because the number of possible worlds grows exponentially in the number of imprecise facts. Allocations can compactly encode this exponentially large set but the challenge now is to summarize without having to explicitly use the allocations to iterate over all possible worlds. Therefore, efficient algorithms for summarizing various aggregation operators using the extended data model have been designed and are disclosed herein.

Consider the following. Fix a query Q whose associated region is q. The set of facts that potentially contribute to the answer are those that have positive allocation to q. If c(r)={c|p_{c,r}>0} denotes the set of cells to which fact r has strictly positive allocations, the desired set of facts is given by R(Q)={r|C(r)∩q≠φ}. Thus, R(Q) is the set of candidate facts for the query Q. For any candidate fact r, let Yᵣ=Y_{r,Q} be the 0-1 indicator random variable for the event that a possible completion of r belongs to q. Therefore,
Pr[Yᵣ=1]=Σ_{cεC(r)∩q}P_{c,r}

Since Yᵣ is a 0-1 random variable, Pr[Yᵣ=1]=E[Yᵣ]; the above equation says that E[Yᵣ] equals the sum of the allocations of r to the query region of Q. With a slight abuse of notation, we say that E[Yᵣ] is the allocation of r to the query Q; it is full if E[Yᵣ]=1 and partial otherwise. Finally, note that the independence assumption in this modeling of imprecision implies that the random variables Yᵣ for the different r's are statistically independent.

The query Q can be answered in the extended data model in two steps. In the first the set of candidate facts rεR(Q) is identified and the corresponding allocations to Q are computed. The former is accomplished by using a filter for the query region whereas the latter is accomplished by identifying groups of facts that share the same identifier in the ID column and then summing up the allocations within each group. At the end of this step, a set of facts is identified that contains for each fact rεR(Q), the allocation of r to Q and the measure value associated with r. Note that this step depends only on the query region q. The second step is specialized to the aggregation operator. This step seeks to identify the information necessary to compute the summarization while circumventing the enumeration of possible worlds. It is noted that it is possible in some cases to merge this second step with the first in order to gain further savings, e.g., the expected value of SUM can be computed thus. This extra optimization step will not be discussed further.

Regarding a SUM query, the random variable corresponding to the answer for a SUM query Q developed for inclusion in the query semantics (at process 114) is given by Z=Σ_{rεR(Q)}vᵣYᵣ. Using this expression, the expectation and variance for SUM can be efficiently computed using an algorithm (see process 128). Specifically, it is theorized that the expectation and variance can be computed exactly for SUM by a single pass over the set of candidate facts. The expectation of the sum computed from the extended data model satisfies SUM-consistency. For SUM, β-faithfulness can be violated if the extended data model was built using arbitrary allocation policies. A class of allocation policies can be defined to guarantee faithfulness. For example, a Monotone Allocation Policy can be defined. Let D and D′ be two similar data sets with the property that the associated regions are identical for every pair of corresponding facts, except for a single pair (r, r′), rεD, r′εD′ such that reg(r′)=reg(r)∪{c*}, for some cell c*. Fix an allocation policy A, and let p_{c,r}(resp.p′_{c,r}) denote the resulting allocations in D (resp.D′) computed with respect to A. A can be the monotonic allocation policy if P_{c,s}≧P′_{c,s} for every fact s and for every cell c≠c*. Monotonicity is a strong but reasonable and intuitive property of allocation policies. When the database has no imprecision, there is a unique possible world with weight 1. But as the amount of imprecision increases, the set of possible worlds will increase as well. Monotone allocation policies restrict the way in which the weights for the larger set of possible worlds are defined. In particular, as a region gets larger, allocations for the old cells are redistributed to the new cells. Thus, it is theorized that the expectation of SUM satisfies SUM-faithfulness if the allocation policy used to build the extended data model is monotone.

Regarding an AVERAGE query, the random variable corresponding to the answer for an AVERAGE query developed for inclusion in the query semantics (at process 114) is given by

$$Z = \frac{{\sum }_{r ∈ ℜ ( Q )} {v}_{r} {Y}_{r}}{{\sum }_{r ∈ ℜ ( Q )} {Y}_{r}} .$$

Unfortunately, computing even the expectation becomes difficult because of the appearance of Yᵣ in both the numerator and denominator. As shown in the following theorem, a non-trivial algorithm for AVERAGE is devised (see process 128). Specifically, it is theorized that if n and m are the number of partially and completely allocated facts in a query region, respectively, then the exact expected value of AVERAGE can be computed in time O(m+n³), with n passes over the set of candidate facts. While the above algorithm is feasible, the cost of computing the exact AVERAGE is high if the number of partially allocated facts for Q is high. To address this issue, it is theorized that an approximate estimate for AVERAGE can be computed in time O(m+n) using a single pass over the set of candidate facts. Thus, the relative error of the estimate is negligible when n [symbol] [symbol] m. The assumption of n [symbol] [symbol] m in the theorem above is reasonable for most databases since we expect that the fraction of facts with missing values that contribute to any query will be small.

Based on a comparison of the two solutions for AVERAGE, discussed above, namely the exact and the approximate estimate in terms of the requirements it can be theorized that (1) the expectation of the AVERAGE computed from the extended data model satisfies basic faithfulness but not AVERAGE-Consistency and (2) that the approximate estimate for AVERAGE defined above satisfies AVERAGE-consistency and basic faithfulness. These theorems show the tradeoff between being accurate in answering queries and being consistent. Given the efficiency aspects and the small relative error (under reasonable conditions) for the approximate estimate, using this estimate for answering queries is proposed.

LinOP, discussed above, was proposed as a reasonable aggregation operator for uncertain measures. The issue of summarizing LinOp over the possible worlds is now addressed. One approach is to compute LinOp over all the facts in all the worlds simultaneously, where the facts in a world Dᵢ are weighted by the probability of that world wᵢ. This is somewhat analogous to the approximate estimate for AVERAGE described above. Consider an aggregated LinOP query. Let D₁, D₂, . . . , Dₘ be the possible worlds with weights w₁, . . . wₘ respectively. Fix a query Q, and let W(r) denote the set of i's such that the cell to which r is mapped in Dᵢ belongs to reg(Q). Thus, the answer for an AggLinOP query developed for inclusion in the query semantics (at process 114) can be defined as

$$\frac{{\sum }_{r ∈ R ( Q )} {\sum }_{i ∈ W ( r )} {v}_{r} {w}_{i}}{{\sum }_{r ∈ R ( Q )} {\sum }_{i ∈ W ( r )} {w}_{i}} ,$$

where the vector vᵣ represent the measure pdf of r. Similar to the approximate estimate for AVERAGE, AggLinOp can be computed efficiently, and satisfies similar kinds of requirements. Specifically, it is theorized that AggLinOp can be computed in a single pass over the set of candidate facts, and satisfies LinOp-Consistency and basic faithfulness (at process 128).

Regarding allocation policies and building the extended data model from the imprecise data via those policies, efficient algorithms are disclosed herein for various aggregation operators in the extended data model. These algorithms prove several consistency and faithfulness properties. The extended data model can be built from the imprecise data via the appropriate allocation policies (i.e., design algorithms) to obtain P,r for every imprecise fact r and every cell cεreg(r). As discussed above regarding FIGS. 2-3, let A₁, A₂, . . . , Aₖ denote the dimension attributes. For any fact r, recall from that reg(r) equals some k-dimensional hyper-rectangle C₁×C₂× . . . Cₖ of cells, where each Cᵢ is a subset of the leaf nodes in dom(Aᵢ). Each cell cεreg(r) is defined by a tuple (c₁, c₂, . . . , cₖ) where cᵢεCᵢ. Therefore, allocating r to the cell c amounts to replacing the i-th attribute value with cᵢ for every i allocate them. The allocation policies discussed herein are categorize as dimension-independent, measure-oblivious, or correlation-preserving.

An allocation policy is said to be dimension-independent if the following property holds for every fact r. Suppose reg(r)=C₁×C₂× . . . Cₖ. Then, for every i and every bεCᵢ, there exist values γᵢ(b) such that (1) Σ_{bεC}_{ᵢ}γᵢ(b)=1 and (2) if c=(c₁, c₂, . . . , cₖ, then p_{c,r}=Πᵢγᵢ(cᵢ). This definition can be interpreted in probabilistic terms as choosing independently for each i, a leaf node cᵢεCᵢ with probability γᵢ(cᵢ). Part (1) in the above definition ensures that γᵢ defines a legal probability distribution on Cᵢ. Part (2) says that the allocation p_{c,r} equals probability that the cell c is chosen by this process. A uniform allocation policy is one where each fact r is uniformly allocated to every cell in reg(r), and is perhaps the simplest of all policies. It is theorized that a uniform allocation is a dimension-independent and monotone allocation policy. Even though this policy is simple to implement, a drawback is that the size of the extended data model (which depends on the number of cells with non-zero probabilities) becomes prohibitively large when there are imprecise facts with large regions.

An allocation policy is said to be measure-oblivious if the following holds. Let D be any database and let D′ be obtained from D by possibly modifying the measure attribute values in each fact r arbitrarily but keeping the dimension attribute values in r intact. Then, the allocations produced by the policy are identical for corresponding facts in D and D′. Strictly speaking uniform allocation is also a measure-oblivious policy. However, in general, policies in this class do not require the dimensions to be independent. An example of such a policy is count-based allocation. Here, the data is divided into two groups consisting of precise and imprecise facts. Let N_{c} denote the number of precise facts that map to cell c. For each imprecise fact r and cell c,

$${p}_{c , r} = \frac{{N}_{c}}{{\sum }_{d ∈ reg ( r )} {N}_{d}}$$

Thus, the allocation of imprecise facts is determined by the distribution of the precise facts in the cells of the multidimensional space. It is theorized that count-based allocation is a measure-oblivious and monotone allocation policy. A potential drawback of count-based allocation is that once the imprecise facts have been allocated, there is a “rich get richer” effect. To understand this, consider a region. Before allocation, this region has a certain distribution of precise facts over the cells of the region. After count-based allocation, it is highly conceivable that this distribution might be significantly different. In some cases it may be desirable to retain the original distribution exhibited by the precise facts. Applying this requirement to the entire multi-dimensional space motivates the introduction of the correlation-preserving class of policies.

An allocation policy can also be a correlation-preserving allocation policy. Let corr( ) be a correlation function that can be applied to any database consisting only of precise facts. Let Δ( ) be a function that can be used to compute the distance between the results of applying corr( ) to precise databases. Let A be any allocation policy. For any database D consisting of precise and imprecise facts, let D₁, D₂, . . . , Dₘ be the set of possible worlds for D. Let the P_{c,r}'s denote the allocations produced by A on D. Recall by definition 16, that the P_{c,r}'s define a weight wᵢ for Dᵢ, iε1 . . . m. The quantity Δ(corr(D₀), Σᵢwᵢ·corr(Dᵢ)) is called the correlation distance of A with respect to D. The allocation policy A is correlation-preserving if for every database D, the correlation distance of A with respect D is the minimum over all policies. By instantiating corr( ) with the pdf over dimension and measure attributes (A₁, . . . , Aₖ, M) and Δ with the Kullback-Leibler divergence D_{KL}, following Definition 22, we can obtain wᵢ by minimizing D_{KL} (P₀, ΣᵢwᵢPᵢ), where Pᵢ=corr(Dᵢ), iε0 . . . m. Unfortunately, this is a difficult optimization problem since there are an exponentially large number of possible worlds.

Additionally, an embodiment of the method can incorporate a surrogate objective function. For example, let P denote the pdf ΣᵢwᵢP in the above expression D_{KL}(P₀, ΣᵢwᵢPᵢ), where the wᵢ's are determined from the unknown p_{c,r}'s. Since P is a pdf, an appropriate direction that is taken in statistical learning is to treat P as a “statistical model” and obtain the parameters of P by maximizing the likelihood of given data D with respect to P. We will later show how to obtain the allocation weights once we have solved for the parameters of P. The advantage of this embodiment of the method is that it also generalizes very well to the case of uncertain measures, which we now proceed to derive below.

Recall that the value for a fixed uncertain measure attribute in fact r is denoted by the vector vᵣ, where vᵣ(o) is the probability associated with the base domain element o. If vᵣ(o) are viewed as empirical distributions induced by a given sample (i.e., defined by frequencies of events in the sample) then uncertain measures are simply summaries of several individual observations for each fact. Consequently, the likelihood function for this case can written as well. After some simple but not obvious algebra, following objective function can be obtained that is equivalent to the likelihood function:

$${\sum }_{r} {D}_{KL} ( \frac{{v}_{r} , {\sum }_{c ∈ reg ( r )} {P}_{c}}{\vert reg ( r ) \vert} ) ,$$

where P_{c} is the measure distribution for cell c.

The vast literature on nonlinear optimization, e.g., see reference [7], provides several algorithms to obtain a solution for the above optimization problem. But goal of the embodiment, disclosed herein, is to obtain the allocation weights P_{c,r}, which do not appear in this objective function. Fortunately, however, the mechanics of the E-M algorithm, described in reference [8], provide an elegant solution. As described below the dual variables in the E-M algorithm can be naturally associated with the allocation weights thus providing a convenient link back to the possible world semantics. The E-M algorithm is first presented in below for the likelihood function.

$$\begin{matrix}Repeat until Converged \text{:} E \text{-} step \text{:} For all facts r , cells c ∈ reg ( r ) , o \\ Q ( c \vert r , o ) := \frac{{p}_{c}^{[ l ]} ( o )}{{\sum }_{{c}^{′}} {p}_{{c}^{′}}^{[ l ]} ( o )} \\ M \text{-} step \text{:} For all cells c , o \\ {P}_{c}^{[ t + 1 ]} ( o ) := \frac{{\sum }_{r ; c ∈ reg ( r )} {v}_{r} ( o ) Q ( c \vert r , o )}{{\sum }_{{o}^{′}} {\sum }_{; rc ∈ reg ( r )} {v}_{r} ( {o}^{′} ) Q ( c \vert r , {o}^{′} )} . \\ & 1\end{matrix}$$

The details of the fairly standard derivation are omitted in the interest of space. Consider now the result of the E-step where we obtain Q(c|r,o). At convergence of the algorithm this represents the posterior distribution over the different values of cεreg(r). An alternate pleasing interpretation, disclosed herein, is to view them as the dual variables (see reference [9]). In either view, Q(c|r,o), is very close to our requirement of allocations. One complication is the added dependency on the measure domain o. Each fact r now has as many allocation weights as the number of possible values of o. This is inconsistent with our extended data model. However, this can be easily rectified by marginalizing Q(c|r,o) over o resulting in the following expression.

$${p}_{c , r} = Q ( c \vert r ) := {\sum }_{o} \frac{{P}_{c}^{[ ∞ ]} ( o )}{{\sum }_{{c}^{′}} {P}_{c}^{[ ∞ ]} ( o )} r , ( o )$$

Allocation policies for numeric measures can also be derived along the lines of the algorithm described above in a straightforward manner and are omitted in the interests of space.

The embodiments of the invention, described above, can be implemented by an entirely hardware embodiment, an entirely software embodiment (e.g., implemented by electronic design automation (EDA) software) or an embodiment including both hardware and software elements. In an embodiment, the invention is implemented in software, which includes but is not limited to firmware, resident software, microcode, etc. Furthermore, embodiments of the invention can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

Therefore, disclosed above are embodiments of a method for online analytic processing of queries and, and more particularly, of a method that extends the on-line analytic processing (OLAP) data model to represent data ambiguity, such as imprecision and uncertainty, in data values. Specifically, embodiments of the method identify natural query properties and use them to shed light on alternative query semantics. The embodiments incorporate a statistical model that allows for uncertain data to be modeled as conditional probabilities and introduces an allocation-based approach to developing the semantics of aggregation queries over imprecise data. This enables a solution which is formally related to existing, popular algorithms for aggregating probability distributions.

A significant advantage of the disclosed method is the direct mapping of the statistical model to star schemas in database (i.e., a popular data model for representing dimensions and measures in relational databases). This fact combined with the mapping of queries to existing standard query language (SQL) aggregation operators enables the solution to be integrated seamlessly into existing OLAP infrastructure so that it may be applied to real-life massive data sets that arise in decision support systems.

The present invention and the various features and advantageous details thereof are explained more fully with reference to the non-limiting embodiments that are illustrated in the accompanying drawings and detailed in the following description. It should be noted that the features illustrated in the drawings are not necessarily drawn to scale. Descriptions of well-known components and processing techniques are omitted so as to not unnecessarily obscure the present invention. The examples used herein are intended merely to facilitate an understanding of ways in which the invention may be practiced and to further enable those of skill in the art to practice the invention. Accordingly, the examples should not be construed as limiting the scope of the invention. Additionally, those skilled in the art will recognize that the invention can be practiced with modification within the spirit and scope of the appended claims.

### REFERENCES

[1] H. Zhu, S. Vaithyanathan, and M. V. Joshi. Knowledge discovery in databases: Pkdd 2003, 7th European conference on principles and practice of knowledge discovery in databases, cavtat-dubrovnik, croatia, Sep. 22-26, 2003, proceedings. In N. Lavrac, D. Gamberger, H. Blockeel, and L. Todorovski, editors, PKDD, volume 2838 of Lecture Notes in Computer Science. Springer, 2003.
[2] C. Genest and J. V. Zidek. Combining probability distributions: A critique and an annotated bibliography (avec discussion). Statistical Science, 1:114-148, 1986.
[3] A. Garg, T. S. Jayram, S. Vaithyanathan, and H. Zhu. Model based opinion pooling. In 8th International Symposium on Artificial Intelligence and Mathematics, 2004.
[4] H. J. Lenz and A. Shoshani. Summarizability in olap and statistical data bases. In Y. E. Ioannidis and D. M. Hansen, editors, SSDBM, pages 132-143. IEEE Computer Society, 1997.
[5] H. J. Lenz and B. Thalheim. Olap databases and aggregation functions. In SSDBM, pages 91-100. IEEE Computer Society, 2001.
[6] S. Abiteboul, P. C. Kanellakis, and G. Grahne. On the representation and querying of sets of possible worlds. In U. Dayal and I. L. Traiger, editors, SIGMOD Conference, pages 34-48. ACM Press, 1987.
[7] D. Bertsekas. 1999.
[8] A. Dempster, N. Laird, and D. Rubin. Maximum likelihood from incomplete data via the EM algorithm. Journal of the Royal Statistical Society, B, 1977.
[9] T. Minka. Expectation-maximization as lower bound maximization, 1998.

What is claimed is:

1. A method of handling queries over ambiguous data, said method comprising:
associating a plurality of facts with a plurality of values, wherein said values comprise at least one of known values, uncertain values and imprecise values;
establishing a base domain comprising said plurality of said values;
representing said uncertain values as probability distribution functions over said values in said base domain;
representing said imprecise values as subsets of said values in said base domain;
receiving a query related to at least one of said facts; and
developing query semantics by using an allocation-based approach for any imprecise values in said query, by aggregating any probability distribution functions for uncertain values associated with said at least one of said facts and by aggregating any known values associated with said at least one of said facts.

2. The method of claim 1, wherein said using of said allocation-based approach to define semantics for said queries comprises determining all possible values for a specific imprecise value associated with said at least one of said facts, determining the probabilities that each of said possible values is said specific imprecise value and allocating weights to each of said possible values based on said probabilities.

3. The method of claim 2, wherein said allocating of said weights to each of said possible values may be iterative.

4. The method of claim 1, wherein each of said probability distribution functions indicates different probabilities associated with a corresponding uncertain value being one of different specific values and within different ranges of specific values.

5. The method of claim 1, wherein said probability distribution functions are aggregated by applying an aggregation operator to said probability distribution functions that are associated with said at least one of said facts.

6. The method of claim 1, wherein prior to aggregating said probability distribution functions, selectively weighting said probability distribution functions.

7. The method of claim 1, wherein said base domain comprises text and wherein said method further comprises using a text classifier to analyze said text and to output said probability distribution functions.

8. The method of claim 1, wherein said method is implemented using an OLAP system.

9. The method of claim 1, wherein said allocation-based approach is used for any of said imprecise values that are contained in said query and for any of said imprecise values that overlap said query.

10. A method of handling queries over ambiguous data, said method comprising:
associating a plurality of facts with a plurality of values, wherein said values comprises at least one of known values, uncertain values and imprecise values;
establishing a base domain comprising said plurality of said values;
representing said uncertain values as probability distribution functions over said values in said base domain;
representing said imprecise values as subsets of said values in said base domain;
receiving an aggregation query related to at least one of said facts, wherein said aggregation query comprises at least one of a SUM query, an AVERAGE query and an aggregation linear operation query; and
developing query semantics by using an allocation-based approach for any imprecise values in said query, by aggregating any probability distribution functions for uncertain values associated with said at least one of said facts and by aggregating any known values associated with said at least one of said facts;
wherein said query semantics are develop so as to comprise at least one of first formula for determining a first answer to said SUM query based on known values associated with said at least one of said facts, a second formula for determining a second answer to said AVERAGE query based on known values associated with said at least one facts and a third formula for determining a third answer for said aggregation linear operation (AggLinOP) query based on uncertain values associated with said at least one fact.

11. The method of claim 10, further comprising implementing said semantics by using a first algorithm for computing said first formula, a second algorithm for computing said second formula and a third algorithm for computing said third formula.

12. The method of claim 10, wherein said using of said allocation-based approach to define semantics for said queries comprises determining all possible values for a specific imprecise value associated with said at least one of said facts, determining the probabilities that each of said possible values is said specific imprecise value and allocating weights to each of said possible values based on said probabilities.

13. The method of claim 12, wherein said allocating of said weights to each of said possible values may be iterative.

14. The method of claim 10, wherein each probability distribution function indicates the different probabilities that are associated with a corresponding uncertain value being one of different specific values and within different ranges of specific values.

15. The method of claim 10, wherein said probability distribution functions are aggregated by applying an aggregation operator to said probability distribution functions that are associated with said at least one of said facts.

16. The method of claim 10, wherein prior to aggregating said probability distribution functions, selectively weighting said probability distribution functions.

17. The method of claim 10, wherein said base domain comprises text and wherein said method further comprises using a text classifier to analyze said text and to output said probability distribution functions.

18. The method of claim 10, wherein said method is implemented using an OLAP system.

19. The method of claim 10, wherein said allocation-based approach is used for any of said imprecise values that are contained in said query and for any of said imprecise values that overlap said query.

20. A program storage device readable by computer and tangibly embodying a program of instructions executable by said computer to perform a method of handling queries over imprecise data, said method comprising:
associating a plurality of facts with a plurality of values, wherein said values comprises at least one of known values, uncertain values and imprecise values;
establishing a base domain comprising said plurality of said values;
representing said uncertain values as probability distribution functions over said values in said base domain;
representing said imprecise values as subsets of said values in said base domain;
receiving a query related to at least one of said facts; and
developing query semantics by using an allocation-based approach for any imprecise values in said query, by aggregating any probability distribution functions for uncertain values associated with said at least one of said facts and by aggregating any known values associated with said at least one of said facts.
